(19) United States
(12) Patent Application Publication
(10) Pub. No.: US 2023/0054179 A1
(43) Pub. Date: Feb. 23, 2023

(54) Metal powder for additive manufacturing

(71) Applicant: ArcelorMittal, Luxembourg (LU)

(72) Inventors: Rosalia REMENTERIA FERNANDEZ, Aviles, Asturias (ES); Frédéric BONNET, Maizières-lès-Metz (FR); Maria Elena CORRAL CORRALES, Infiesto (ES); Carla OBERBILLIG, Maizières-lès-Metz (FR)

(21) Appl. No.: 17/785,675

(22) PCT Filed: Dec. 14, 2020
(86) PCT No.: PCT/IB2020/061889

§ 371 Date: Jun. 15, 2022

(30) Foreign Application Priority Data
Dec. 20, 2019 (IB) PCT/IB2019/061165

(51) Int. Cl. B22F 9/08; B22F 10/25; B22F 10/28; C22C 38/00; C22C 38/02; C22C 38/04; C22C 38/06; C22C 38/42; C22C 38/46; C22C 38/50; C22C 38/54

(52) U.S. Cl. CPC B22F 9/082; B22F 10/25; B22F 10/28; C22C 38/002; C22C 38/02; C22C 38/04; C22C 38/06; C22C 38/42; C22C 38/46; C22C 38/50; C22C 38/54; B33Y 10/00

(57) ABSTRACT

A metal powder for additive manufacturing having a composition including the following elements, expressed in content by weight: 0.01%≤C≤0.2%, 4.6%≤Ti≤10%, (0.45×Ti)−0.22%≤B≤(0.45×Ti)+0.70%, S≤0.03%, P≤0.04%, N≤0.05%, O≤0.05% and optionally containing: Si≤1.5%, Mn≤3%, Al≤1.5%, Ni≤1%, Mo≤1%, Cr≤3%, Cu≤1%, Nb≤0.1%, V≤0.5% and including eutectic precipitates of TiB₂ and Fe₂B, the balance being Fe and unavoidable impurities resulting from the elaboration, the volume percentage of TiB₂ being equal or more than 10% and the mean bulk density of the powder being 7.50 g/cm³ or less. A manufacturing method by atomization is also provided.

The present invention relates to a metal powder for the manufacturing of steel parts and in particular for their use for additive manufacturing. The present invention also relates to the method for manufacturing the metal powder.

### BACKGROUND

FeTiB₂ steels have been attracting much attention due to their excellent high elastic modulus E, low density and high tensile strength. However, such steel sheets are difficult to produce by conventional routes with a good yield, which limits their use.

### SUMMARY OF THE INVENTION

It is an object of the present disclosure to provide FeTiB₂ powders that can be efficiently used to manufacture parts by additive manufacturing methods while maintaining good use properties.

The present invention provides a metal powder having a composition comprising the following elements, expressed in content by weight:

0.01%≤C≤0.2%

4.6%≤Ti≤10%

(0.45×Ti)−0.22%≤B≤(0.45×Ti)+0.70%

S≤0.03%

P≤0.04%

N≤0.05%

O≤0.05%

and optionally containing:

Si≤1.5%

Mn≤3%

Al≤1.5%

Ni≤1%

Mo≤1%

Cr≤3%

Cu≤1%

Nb≤0.1%

V≤0.5%

and comprising precipitates of TiB₂ and of Fe₂B, the balance being Fe and unavoidable impurities resulting from the elaboration, the volume percentage of TiB₂ being equal or more than 10% and the mean bulk density of the powder being 7.50 g/cm³ or less.

The present invention also provides a method for manufacturing a metal powder for additive manufacturing, comprising:
melting elements and/or metal-alloys at a temperature at least 50° C. above the liquidus temperature so as to obtain a molten composition comprising, expressed in content by weight, 0.01%≤C≤0.2%, 4.6%≤Ti≤10%, (0.45×Ti)−0.22%≤B≤(0.45×Ti)+0.70%, S≤0.03%, P≤0.04%, N≤0.05%, O≤0.05% and optionally containing Si≤1.5%, Mn≤3%, Al≤1.5%, Ni≤1%, Mo≤1%, Cr≤3%, Cu≤1%, Nb≤0.1%, V≤0.5%, the balance being Fe and unavoidable impurities resulting from the elaboration and
atomizing the molten composition through a nozzle with pressurized gas.

### DETAILED DESCRIPTION

The invention will be better understood by reading the following description, which is provided purely for purposes of explanation and is in no way intended to be restrictive.

The powder according to the invention has a specific composition, balanced to obtain good properties when used for manufacturing parts.

The carbon content is limited because of the weldability as the cold crack resistance and the toughness in the HAZ (Heat Affected Zone) decrease when the carbon content is greater than 0.20%. When the carbon content is equal to or less than 0.050% by weight, the resistance weldability is particularly improved.

Because of the titanium content of the steel, the carbon content is preferably limited so as to avoid primary precipitation of TiC and/or Ti(C,N) in the liquid metal. The maximum carbon content must be preferably limited to 0.1% and even better to 0.080% so as to produce the TiC and/or Ti(C,N) precipitates predominantly during solidification or in the solid phase.

Silicon is an optional element but when added contributes effectively to increasing the tensile strength thanks to solid solution hardening. However, excessive addition of silicon causes the formation of adherent oxides that are difficult to remove. To maintain good surface properties, the silicon content must not exceed 1.5% by weight.

Manganese is optional. However, in an amount equal to or greater than 0.06%, manganese increases the hardenability and contributes to the solid-solution hardening and therefore increases the tensile strength. It combines with any sulfur present, thus reducing the risk of hot cracking. But, above a manganese content of 3% by weight, there is a greater risk of forming deleterious segregation of the manganese during solidification.

Aluminum is optional. However, in an amount equal to or greater than 0.005%, aluminum is a very effective element for deoxidizing the steel. But, above a content of 1.5% by weight, excessive primary precipitation of alumina takes place, causing processing problems.

In an amount greater than 0.030%, sulfur tends to precipitate in excessively large amounts in the form of manganese sulfides which are detrimental.

Phosphorus is an element known to segregate at the grain boundaries. Its content must not exceed 0.040% to maintain sufficient hot ductility, thereby avoiding cracking.

Optionally, nickel, copper or molybdenum may be added, these elements increasing the tensile strength of the steel. For economic reasons, these additions are limited to 1% by weight.

Optionally, chromium may be added to increase the tensile strength. It also allows larger quantities of carbides to be precipitated. However, its content is limited to 3% by weight to manufacture a less expensive steel. A chromium content equal to or less than 0.080% will preferably be chosen. This is because an excessive addition of chromium results in more carbides being precipitated.

Also optionally, niobium and vanadium may be added respectively in an amount equal to or less than 0.1% and equal to or less than 0.5% so as to obtain complementary hardening in the form of fine precipitated carbonitrides.

Titanium and boron play an important role in the powder according to the invention.

Titanium is present in amount between 4.6% and 10%. When the weight content of titanium is less than 4.6%, TiB₂ precipitation does not occur in sufficient quantity. This is because the volume fraction of precipitated TiB₂ is less than 10%, thereby precluding a significant change in the elastic modulus, which may remains less than 240 GPa. When the weight content of titanium is greater than 10%, coarse primary TiB2 precipitation occurs in the liquid metal and causes problems in the products. Moreover, liquidus temperature increases and a superheat of at least 50° C. cannot be achieved with standard atomization process.

FeTiB₂ eutectic precipitation occurs upon solidification. The eutectic nature of the precipitation gives the microstructure formed a particular fineness and homogeneity advantageous for the mechanical properties. When the amount of TiB₂ eutectic precipitates is greater than 10% by volume of TiB₂ precipitates, the modulus may exceed about 240 GPa, thereby enabling appreciably lightened structures to be designed. This amount may be increased to 15% by volume to exceed about 250 GPa, in the case of steels comprising alloying elements such as chromium or molybdenum. This is because when these elements are present, the maximum amount of TiB₂ that can be obtained in the case of eutectic precipitation is increased.

As explained above, titanium must be present in sufficient amount to cause endogenous TiB₂ formation.

In the frame of the present invention, the “free Ti” here designates the content of Ti not bound under the form of precipitates. The free Ti content can be evaluated as free Ti=Ti−2.215×B, B designating the boron content in the powder.

According to the invention, the titanium and boron contents are such that:

−0.22≤B−(0.45×Ti)≤0.70

In that range, the content of free Ti is less than 0.5%. It is preferred to set the free Ti to a value between 0.30 and 0.40%. The precipitation takes place in the form of two successive eutectics: firstly, FeTiB₂ and then Fe₂B, this second endogenous precipitation of Fe₂B taking place in a greater or lesser amount depending on the boron content of the alloy. The amount precipitated in the form of Fe₂B may range up to 8% by volume. This second precipitation also takes place according to a eutectic scheme, making it possible to obtain a fine uniform distribution, thereby ensuring good uniformity of the mechanical properties.

The precipitation of Fe₂B completes that of TiB₂, the maximum amount of which is linked to the eutectic. The Fe₂B plays a role similar to that of TiB₂. It increases the elastic modulus and reduces the density. It is thus possible for the mechanical properties to be finely adjusted by varying the complement of Fe₂B precipitation relative to TiB₂ precipitation. This can be used in particular to obtain an elastic modulus greater than 250 GPa in the steel. When the steel contains an amount of Fe₂B equal to or greater than 4% by volume, the elastic modulus increases by more than 5 GPa. When the amount of Fe₂B is greater than 7.5% by volume, the elastic modulus is increased by more than 10 GPa.

The bulk density of the metal powder according to the invention is surprisingly good.

Indeed, the bulk density of the metal powder according to the invention is of a maximum value of 7.50 g/cm³. Thanks to this low density of the powder, the part made of such metal powder through additive manufacturing will present a reduced density together with an improved elastic modulus.

The powder can be obtained, for example, by first mixing and melting pure elements and/or ferroalloys as raw materials. Alternatively, the powder can be obtained by melting pre-alloyed compositions.

Pure elements are usually preferred to avoid having too much impurities coming from the ferroalloys, as these impurities might ease the crystallization. Nevertheless, in the case of the present invention, it has been observed that the impurities coming from the ferroalloys were not detrimental to the achievement of the invention.

The person skilled in the art knows how to mix different ferroalloys and pure elements to reach a targeted composition.

Once the composition has been obtained by the mixing of the pure elements and/or ferroalloys in appropriate proportions, the composition is heated at a temperature at least 50° C. above its liquidus temperature and maintain at this temperature to melt all the raw materials and homogenize the melt. Thanks to this overheating, the decrease in viscosity of the melted composition helps obtaining a powder with good properties. That said, as the surface tension increases with temperature, it is preferred not to heat the composition at a temperature more than 450° C. above its liquidus temperature.

Preferably, the composition is heated at a temperature at least 100° C. above its liquidus temperature. More preferably, the composition is heated at a temperature 300 to 400° C. above its liquidus temperature.

The molten composition is then atomized into fine metal droplets by forcing a molten metal stream through an orifice, the nozzle, at moderate pressures and by impinging it with jets of gas (gas atomization) or of water (water atomization). In the case of the gas atomization, the gas is introduced into the metal stream just before it leaves the nozzle, serving to create turbulence as the entrained gas expands (due to heating) and exits into a large collection volume, the atomizing tower. The latter is filled with gas to promote further turbulence of the molten metal jet. The metal droplets cool down during their fall in the atomizing tower. Gas atomization is preferred because it favors the production of powder particles having a high degree of roundness and a low amount of satellites.

The atomization gas is argon or nitrogen. They both increase the melt viscosity slower than other gases, e.g. helium, which promotes the formation of smaller particle sizes. They also control the purity of the chemistry, avoiding undesired impurities, and play a role in the good morphology of the powder. Finer particles can be obtained with argon than with nitrogen since the molar weight of nitrogen is 14.01 g/mole compared with 39.95 g/mole for argon. On the other hand, the specific heat capacity of nitrogen is 1.04 J/(g K) compared with 0.52 for argon. So, nitrogen increases the cooling rate of the particles.

The gas pressure is of importance since it directly impacts the particle size distribution and the microstructure of the metal powder. In particular, the higher the pressure, the higher the cooling rate. Consequently, the gas pressure is set between 10 and 30 bar to optimize the particle size distribution and favor the formation of the micro/nano-crystalline phase. Preferably, the gas pressure is set between 14 and 18 bar to promote the formation of particles whose size is most compatible with the additive manufacturing techniques.

The nozzle diameter has a direct impact on the molten metal flow rate and, thus, on the particle size distribution and on the cooling rate. The maximum nozzle diameter is usually limited to 4 mm to limit the increase in mean particle size and the decrease in cooling rate. The nozzle diameter is preferably between 2 and 3 mm to more accurately control the particle size distribution and favor the formation of the specific microstructure.

The gas to metal ratio, defined as the ratio between the gas flow rate (in Kg/h) and the metal flow rate (in Kg/h), is preferably kept between 1.5 and 7, more preferably between 3 and 4. It helps adjusting the cooling rate and thus further promotes the formation of the specific microstructure.

According to one variant of the invention, in the event of humidity uptake, the metal powder obtained by atomization is dried to further improve its flowability. Drying is preferably done at 100° C. in a vacuum chamber.

The metal powder obtained by atomization can be either used as such or can be sieved to keep the particles whose size better fits the additive manufacturing technique to be used afterwards. For example, in case of additive manufacturing by Powder Bed Fusion, the range 20-63 μm is preferred. In the case of additive manufacturing by Laser Metal Deposition or Direct Metal Deposition, the range 45-150 μm is preferred.

The parts made of the metal powder according to the invention can be obtained by additive manufacturing techniques such as Powder Bed Fusion (LPBF), Direct metal laser sintering (DMLS), Electron beam melting (EBM), Selective heat sintering (SHS), Selective laser sintering (SLS), Laser Metal Deposition (LMD), Direct Metal Deposition (DMD), Direct Metal Laser Melting (DMLM), Direct Metal Printing (DMP), Laser Cladding (LC), Binder Jetting (BJ), Coatings made of the metal powder according to the invention can also be obtained by manufacturing techniques such as Cold Spray, Thermal Spray, High Velocity Oxygen Fuel.

### Examples

The following examples and tests presented hereunder are non-restricting in nature and must be considered for purposes of illustration only. They will illustrate the advantageous features of the present invention, the significance of the parameters chosen by inventors after extensive experiments and further establish the properties that can be achieved by the metal powder according to the invention.

Metal compositions according to Table 1 were first obtained either by mixing and melting ferroalloys and pure elements in the appropriate proportions or by melting pre-alloyed compositions. The composition, in weight percentage, of the added elements are gathered in Table 1.

TABLE 1
Melt composition

| Sample | C | Ti | B | Mn | Al | Si | S | P | V | Ni | Cr | Cu |
|---|---|---|---|---|---|---|---|---|---|---|---|---|
| C76 | 0.053 | 5.70 | 2.20 | <0.001 | 0.316 | 0.571 | 0.007 | 0.002 | 0.213 | <0.001 | <0.001 | <0.001 |
| C75 | 0.052 | 5.69 | 2.19 | <0.001 | <0.001 | <0.001 | <0.001 | <0.001 | 0.213 | <0.001 | <0.001 | <0.001 |
| C27 | 0.019 | 4.81 | 1.99 | 0.189 | 0.046 | 0.068 | 0.001 | 0.0090 | 0 | 0.045 | 0.033 | 0.05 |
| C28 | 0.019 | 4.81 | 1.99 | 0.189 | 0.046 | 0.068 | 0.001 | 0.0090 | 0 | 0.045 | 0.033 | 0.05 |

Nitrogen and oxygen amounts were below 0.001% for all samples.

These metal compositions were heated up and then gas atomized with argon or nitrogen in the process conditions gathered in Table 2.

TABLE 2
Atomization parameters
For all trials, the common input parameters of the atomizer BluePower
AU3000 were:

| Start ΔP | 60 | mbar |
|---|---|---|
| End ΔP | 140 | mbar |
| Time ΔP | 1.5 | min |
| Atomizing Gas Pressure | 24 | bar |
| Gas Start Delay Time | 1-2 | s |
| Crucible/Stopper Rod Material | Al₂O₃/Al₂O₃ | |
| Crucible Outlet Diameter | 3.0 | mm |

| Crucible Outlet Material | | | | | | | Boron Nitride | | |
|---|---|---|---|---|---|---|---|---|---|
| | Overheat | Holding | Atom T | Atom | Gas T | Atom t, | | | |
| Batch | T (° C.) | t (min) | (° C.) | gas | (° C.) | mm:ss | F1, % | F2, % | F3, % |
| C76 | 250 | 45 | 1544 | Ar | 200 | 0:59 | 15.6 | 36.2 | 33.6 |
| C75 | 250 | 45 | 1546 | N₂ | 200 | 1:20 | 18.2 | 30.7 | 28.7 |
| C27 | 260 | 45 | 1554 | N₂ | 200 | 1:05 | 11.9 | 19.3 | 33.6 |
| C28 | 100 | 44 | 1396 | N₂ | 200 | 1:03 | 10.5 | 19.7 | 32.1 |

The obtained metal powders were then dried at 100° C. under vacuum for 0.5 to 1 day and sieved to be separated in three fractions F1 to F3 according to their size. Fraction F1 correspond to size between 1 and 19 μm. Fraction F2 correspond to size between 20 and 63 μm and fraction F3 correspond to size above 63 μm.

The elemental composition of the powders, in weight percentage, was analyzed and main elements were gathered in table 3. All other elements contents were within the invention ranges.

TABLE 3
Powder composition

| | | | | TiB₂ | |
|---|---|---|---|---|---|
| Sample | Ti | B | Free Ti | (% vol) | Fe₂B |
| C76 | 3.22 | 1.52 | 0 | 7.8 | Yes |
| C75 | 3.63 | 1.70 | 0 | 8.8 | Yes |
| C27 | 4.76 | 1.99 | 0.35 | 10.6 | Yes |
| C28 | 4.87 | 2.03 | 0.37 | 10.8 | Yes |

The bulk density of the powders was determined and gathered in table 4.

TABLE 4
Bulk density

| | | | F2 fraction | |
|---|---|---|---|---|
| | | | Bulk density | TiB₂ |
| Sample | ΔT(° C.) | Atm | (g/cm³) | (% vol) |
| C76 | 250 | Ar | 7.64 | 7.8 |
| C75 | 250 | N₂ | 7.63 | 8.8 |
| C27* | 260 | N₂ | 7.50 | 10.6 |
| C28* | 100 | N₂ | 7.47 | 10.8 |

*samples according to the invention,
underlined values: out of the invention

The bulk density was measured using commercial Pycnometer AccuPyc II 1340. It is based on gas pycnometry using Ar atm. Such method is more accurate than Archimedes principle using liquid systems for powder density due to wettability issues.

Samples are preliminary dried to eliminate moisture. Helium is used for its small atomic diameter to penetrate in small cavities.

The measurement method is based on He injection at a given pressure in a first reference chamber, then the gas is released in a second chamber containing the powder. Pressure in this second chamber is measured.

Mariotte's law is then used to calculate the powder volume V_{É}

$${P}_{1} \cdot {V}_{1} = {P}_{2} ( {V}_{0} + {V}_{1} - {V}_{\dot{E}} ) \\ {V}_{\dot{E}} = {V}_{0} - {V}_{1} ( \frac{{P}_{1}}{{P}_{2}} - 1 )$$

with
   V₁, volume of the first reference chamber
   V₀, volume of the second chamber containing the powder sample
   V_{É}, volume of powder
   P₁, gas pressure in the first reference chamber
   P₂, gas pressure in the second chamber containing the powder sample

The weight of the sample is measured with a calibrated balance and the corresponding density is then calculated.

It is clear from the examples that the powder according to the invention presents a reduced density at a level of 7.50 g/cm³ or below, compared to the reference examples which density is significantly higher. This result is surprising as the corresponding values of TiB₂ percentages in volume are not in line with such a gap in density.

1-8. (canceled)

9. A metal powder having a composition comprising the following elements, expressed in content by weight:
0.01%≤C≤0.2%
4.6%≤Ti≤10%
(0.45×Ti)−0.22%≤B≤(0.45×Ti)+0.70%
S≤0.03%
P≤0.04%
N≤0.05%
O≤0.05%
and optionally containing:
Si≤1.5%
Mn≤3%
Al≤1.5%
Ni≤1%
Mo≤1%
Cr≤3%
Cu≤1%
Nb≤0.1%
V≤0.5%
and including precipitates of TiB₂ and of Fe₂B, a balance being Fe and unavoidable impurities resulting from processing, a volume percentage of TiB₂ being equal or more than 10% and a mean bulk density of the powder being 7.50 g/cm³ or less.

10. The metal powder as recited in claim 9 wherein the volume percentage of Fe₂B is of at least 4%.

11. The metal powder as recited in claim 9 wherein a free Ti content of the powder is comprised between 0.30 and 0.40% in weight.

12. A method for manufacturing a metal powder for additive manufacturing, comprising:
melting elements or metal-alloys at a temperature at least 50° C. above a liquidus temperature so as to obtain a molten composition including, expressed in content by weight, 0.01%≤C≤0.2%, 4.6%≤Ti≤10%, (0.45×Ti)+0.22%≤B≤(0.45×Ti)+0.70%, S≤0.03%, P≤0.04%, N≤0.05%, O≤0.05% and optionally containing Si≤1.5%, Mn≤3%, Al≤1.5%, Ni≤1%, Mo≤1%, Cr≤3%, Cu≤1%, Nb≤0.1%, V≤0.5%, a balance being Fe and unavoidable impurities resulting from processing; and
atomizing the molten composition through a nozzle with pressurized gas.

13. The method as recited in claim 12 wherein the melting is done at a temperature at least 100° C. above the liquidus temperature.

14. The method as recited in claim 12 wherein the melting is done at a temperature at maximum 400° C. above the liquidus temperature.

15. The method as recited in claim 12 wherein the gas is pressurized to between 10 and 30 bar.

16. A metal part obtained through the method as recited in claim 12.

16. A metal part manufactured by an additive manufacturing process using the metal powder as recited in claim 9.
